(19) United States
(12) Patent Application Publication
(10) Pub. No.: US 2026/0363491 A1
(43) Pub. Date: Nov. 19, 2026

(54) CUTTING BOARD

(71) Applicant: M:VENTION UG (HAFTUNGSBESCHRÄNKT), Datteln (DE)

(72) Inventor: Sebastian MÜHLENBROCK, Datteln (DE)

(21) Appl. No.: 19/154,266

(22) PCT Filed: Jan. 22, 2024
(86) PCT No.: PCT/EP2024/051390

§ 371 Date: Aug. 6, 2025

(30) Foreign Application Priority Data
Feb. 9, 2023 (DE) 20 2023 100 626.4

(51) Int. Cl. A47J 47/00

(52) U.S. Cl. CPC A47J 47/005

(57) ABSTRACT

A chopping cutting board includes a main board on which material to be chopped can be placed for chopping, and connected to the main board, a support board for the material to be chopped. The support board and the main board, when assembled, include an angle of approximately 70° to 120°, in particular approximately 90°.

### CROSS-REFERENCE TO RELATED APPLICATIONS

This application is a 35 U.S.C. § 371 National Stage patent application of PCT/EP2024/051390, filed on 22 Jan. 2024, which claims the benefit of Ger-man patent application 20 2023 100 626.4, filed on 9 Feb. 2023, the disclosures of which are incorporated herein by reference in their entirety.

### TECHNICAL FIELD

The disclosure relates to a cutting board to make it easier to slice bread and other items to be cut.

### BACKGROUND

In particular, bread or a loaf of bread is often cut by hand at home using a knife. In doing so, it is often difficult to cut the slices of bread evenly with a consistent thickness. This issue is exacerbated in particular when the bread to be cut is relatively small or only a small remaining piece is to be cut. Similar issues arise with different types of fruit and vegetables, which often cannot be cut straight and evenly either. Below a certain size, it is sometimes no longer possible to cut by hand at all. Also particularly soft items to be cut, those with a hard crust/skin or those with a loose consistency, which very readily break into smaller pieces, are very difficult to cut neatly, straight and/or thinly.

The prior art discloses various options for facilitating the cutting of items to be cut. For example, electric machines can be used, although these are costly and often too large. Alternatively, various cutting aids are known, although these do not have the desired effect either. In principle, all of these known cutting adis are based on the knife of the user being guided. This is to ensure that a cut, for example vertically downwards or horizontally, always guarantees the desired, in particular consistent, thickness of the cut slices.

For example, document U.S. Pat. No. 1,729,624 discloses a cutting aid which consists of a plurality of arms connected to one another, which are pressed onto the bread from above, wherein the arrangement of the arms provides a guide for a knife.

GB 2 452 608 A describes a cutting aid, in which a base plate is formed with a knife guide. The cutting direction is horizontal, and a foldable stop is provided to hold the bread laterally in the desired position.

Other cutting aids are, for example, described in documents U.S. Pat. No. 2,043,175 A, GB 1 171 725 A, JP S 5 162 381 U, U.S. Pat. No. 5,697,276 A, CN 102 310 424 A and GB 2 310 590 A.

The disadvantage of these known cutting aids is in particular that the knife is guided throughout the entire cutting process. The cutting aid thus specifies the dimensions of the item to be cut; it cannot be influenced by the user during the cutting process. In addition, the knife slips out of the guide during normal-length cutting movements, limiting the movement of the knife and making the cutting process more difficult.

### SUMMARY

The present disclosure involves providing another cutting aid which makes cutting items to be cut as flexible as possible. The cutting aid should be designed to be as simple as possible and intuitive to use.

The disclosure relates to a cutting board, having
a support plate, on which an item to be cut can be placed for the cutting process,
a backing plate for the item to be cut connected to the support plate,
wherein the backing plate and the support plate form an angle of around 70° to 120°, in particular around 90°, in the assembled state.

The disclosure is described hereinafter for use with bread or a loaf of bread. The term bread is merely to be understood as a synonym for any suitable item to be cut, for example also fruit and vegetables.

The cutting board according to the disclosure is very simple in design, but has considerable advantages over the prior art. The cutting board can be used to cut bread straight in a vertical direction. For this, the bread is placed onto the support plate and pressed laterally against the upright backing plate. The knife is then used to cut the bread from top to bottom, wherein the upright backing plate serves as a reference for a straight cut. The lateral support holds and stabilises the bread, which considerably simplifies the cutting process.

A key feature is that the thickness of the slice of bread to be cut can be freely selected and also varied when cutting a plurality of slices of bread without having to make further adjustments to the cutting board.

Advantageously, the bread can also be pressed diagonally against the upright backing plate in order to cut the bread diagonally, for example.

The support plate and backing plate can be fixedly connected to one another; however, in one particularly advantageous embodiment, they are releasably connected to one another. This enables the cutting board to be stored in a space-saving manner before and after use. The support plate preferably has a groove, whose width corresponds substantially to the thickness of the backing plate such that this can be quickly and easily inserted into the groove for use. The groove ensures that the backing plate is arranged vertically, i.e. forms an angle of 90° with the support plate.

Advantageously, a plurality of grooves can also be provided, which are designed in such a way that the inserted backing plate forms an angle with the support plate deviating from 90°. The user than has the choice as to whether, for example, straight slices are to be cut, or whether the bread or item to be cut should be cut diagonally.

The cutting board can be made of any material; production from wood or plastic has proven particularly suitable.

In another advantageous embodiment, the cutting board can have a magnet, which is arranged and designed in such a way that it can hold a metallic object, in particular a knife, on the cutting board. The magnet can, for example, be attached to the side of the backing plate, but it is particularly preferably incorporated into the inside of the backing plate for aesthetic reasons. Alternatively, the magnet can of course also be arranged at another point of the cutting board. A plurality of magnets can also be provided at different points.

Alternatively or in addition, the cutting board can also have a slot for inserting an object, in particular a knife blade. The groove therefore acts as a knife sheath in which the knife can be held before and after use. It has been shown that the slot can be preferably arranged in the backing plate, in particular in a front side wall of the backing plate.

In order to ensure that the bread is cut safely, the support plate has anti-slip elements or feet on its bottom. These increase the coefficient of friction on the surface, preventing or at least making it more difficult for the cutting board to slip during the cutting process. The feet can, for example, be made of a soft plastic. As the cutting process takes place in most applications immediately in front of the backing plate when the disclosure is used, the disclosure has a cutting surface insert here in another variant. The signs of use caused by the use of a knife are thus concentrated in a visually distinct area, creating a better overall appearance despite the signs of use. Moreover, the insert can be made of a harder material than the support plate such that there are fewer signs of use. This material can in particular be a harder type of wood than the support plate, but can also be a completely different material, such as plastic. The cutting surface insert can be fixedly connected to the support plate. In one particularly advantageous embodiment, it is designed so that it can be replaced. The cutting surface insert can be fixed to the support plate to prevent slipping thanks to a form-fitting connection, such as a tongue and groove system. In one particularly advantageous embodiment, the cutting surface insert can magnetically adhere to the support plate. The geometry and size of the insert are not limited to the position directly in front of the backing plate; rather, it can be also be located at another point on the board.

### BRIEF DESCRIPTION OF THE DRAWINGS

The disclosure is explained in more detail based on the following figures. These should not be understood as limiting, rather they merely show one preferred exemplary embodiment of the disclosure. In particular, the individual elements can also have other dimensions. In the drawing:

FIG. 1: shows a first embodiment of the disclosure in a perspective view,

FIG. 2: shows the cutting board shown in FIG. 1 in a side view bread placed on it,

FIG. 3: shows a second embodiment of the disclosure in a perspective view,

FIG. 4: shows the cutting board shown in FIG. 3 in a side view bread placed on it,

FIG. 5: shows an embodiment of the disclosure with a T-shaped profile groove,

FIG. 6: shows an embodiment of the disclosure with a replaceable cutting surface insert, and

FIG. 7: shows another embodiment of the disclosure with a replaceable cutting surface insert.

### DETAILED DESCRIPTION OF THE DRAWINGS

The figures show two different cutting boards 20. These are respectively formed of a support plate 22 that can be placed on a surface and a backing plate 24 attached thereto. An item to be cut 26, such as bread, can be placed on the support plate 22 and pressed laterally against the backing plate 24 (cf. FIGS. 2 and 4). A knife (not shown) is guided from top to bottom to cut the bread, wherein the backing plate 24 provides lateral support for the bread on the one hand, and serves as a reference for a straight cut on the other.

In order to ensure the desired straight cut, the backing plate 24 and support plate 22 form an angle of 90° in the exemplary embodiment shown.

The backing plate 24 is held in a groove 28, which is inserted into the support plate 22. In one particularly advantageous embodiment, the support plate 22 and backing plate 24 are releasably connected to one another, but they can also be bonded together.

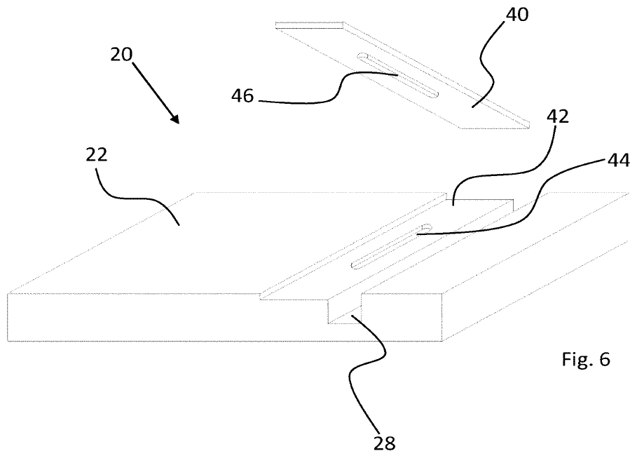

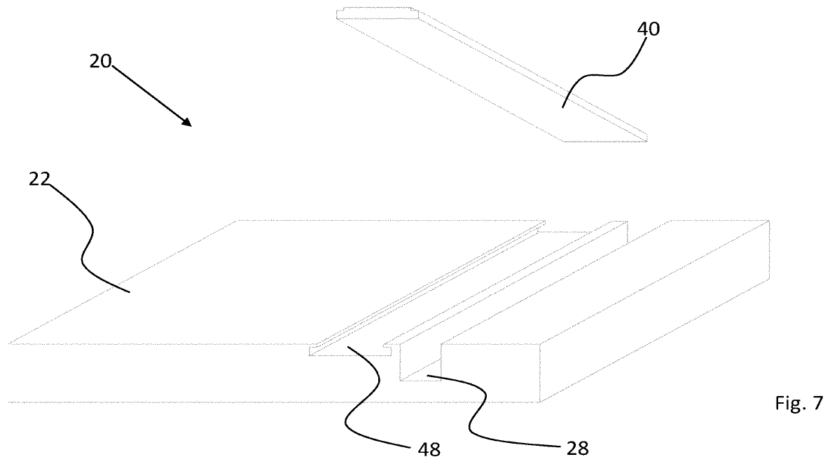

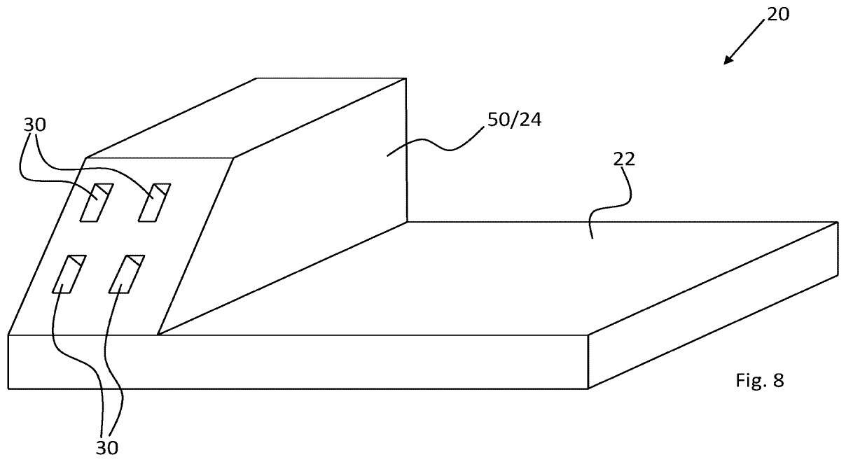

In one particularly advantageous embodiment, the groove 28 is designed as a T-shaped profile groove 28 in cross-section, into which the backing plate 24 can be laterally inserted (see FIG. 5). The backing plate 24 has, for this purpose, a cross-section corresponding to the T-shaped groove 28, for example formed by two grooves (not shown) running parallel in the edge region of the backing plate 24, into which protrusions 25, which protrude into the groove 28 and reduce the width of the groove, can be inserted. Other groove shapes that provide the desired connection can also be used instead of a T-shaped groove.

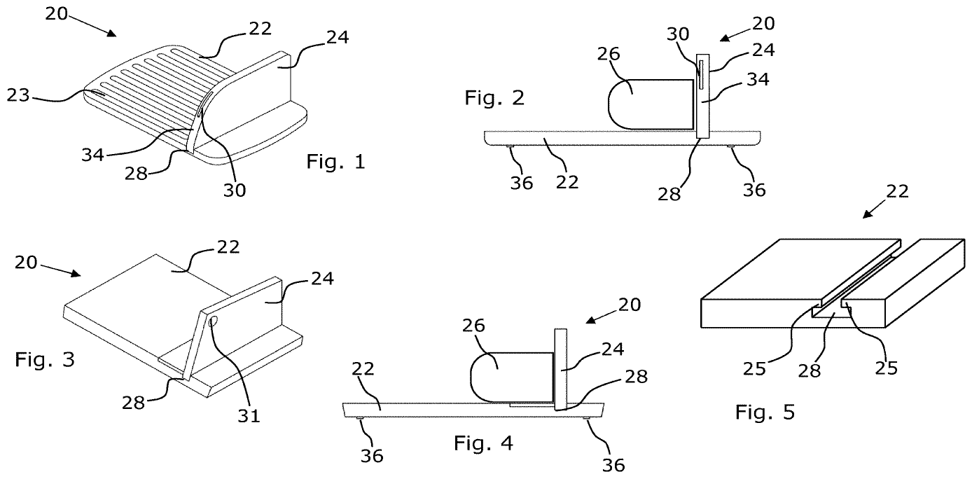

Moreover, other options for connecting the backing plate 24 to the support plate 22 are possible, such as via a screw or nail connection. In one particularly advantageous embodiment, the connection is made by a folding hinge, which connects the two elements to one another and can be folded down for space-saving storage. In the embodiment according to FIG. 1, recesses 23 are inserted into an upper side facing the item to be cut 26, which, on the one hand, are used to catch bread-crumbs, for example, and, on the other, also have a decorative effect.

Furthermore, the embodiments according to FIGS. 1 and 2 show a slot 30 in the backing plate 24, in which a knife blade can preferably be inserted. The knife is therefore always kept ready-for-use in the same place. Alternatively or in addition, one or more magnets (not shown, incorporated into the backing plate 24) can be arranged on or in the backing plate 24, which magnetically hold the knife over the metal knife blade. In particular a combination of the two variants is possible if, for example, a plurality of knives or objects are to be attached to the cutting board 20.

FIG. 3 shows an additional hole 31 in the backing plate 24, which, on the one hand, has a decorative effect, but also makes it easier to grip the backing plate 24, for example, when it is separated from the support plate 22.

Furthermore, FIG. 3 shows a cutting surface insert 40, which is arranged in the region directly in front of the backing plate 24. The signs of use caused by the use of a knife are concentrated by use of the cutting surface insert 40, which can also be made of a more resistant material than the rest of the cutting board 20, in a visually distinct area, creating a better overall appearance despite the signs of use.

The support plate has non-slip feet 36 on its bottom, which make it harder or prevent the cutting board 20 from slipping during the cutting process.

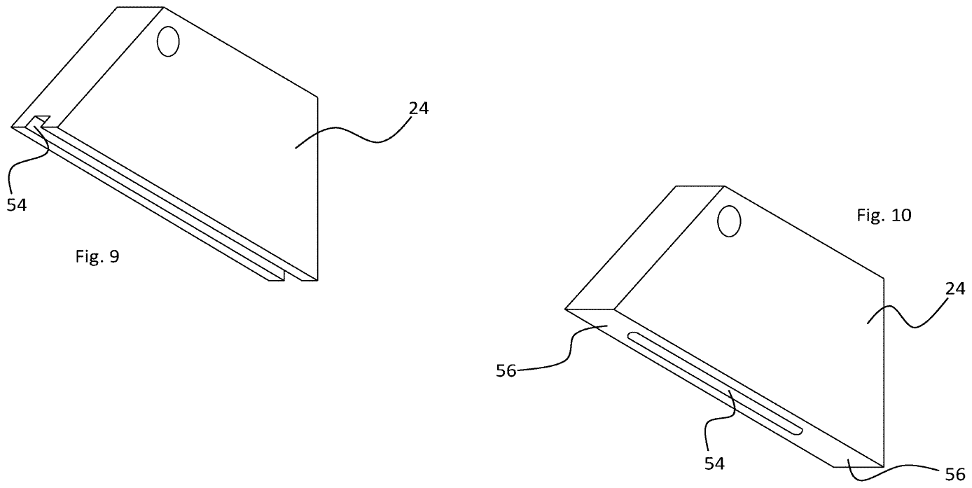

FIG. 6 shows a replaceable design of the cutting surface insert 40 with a tongue and groove system. The cutting surface insert 40 can be inserted into a recess 42 in the support plate 22 such that a continuously flat surface or usable surface of the support plate 22 is formed when the cutting surface insert 40 is placed on it. Securing the cutting surface insert 40 against slipping is not limited to the retaining groove 44 and retaining tongue 46 shown, but rather can also be achieved with any other form-fitting elements. A magnet and a metal element can be incorporated into the cutting surface insert 40 and the support plate 22 or attached thereto, for example, in order to cause the cutting surface insert 40 to adhere to the support plate 22. The magnet can be both in the cutting surface insert 40 and in the support plate 22. Two magnets can also be used instead of a magnet and metal element. Form-fitting elements can also be used to prevent the cutting surface insert 40 from detaching from the support plate 22, such as snap hooks and eyelets. All of these elements can also be used in combination.

FIG. 7 shows an alternative connection of the cutting surface insert 40 to the support plate 22. The cutting surface insert 40 and the support plate 22 are designed in such a way that the cutting surface insert 40 can be inserted laterally into a designated recess 48. The geometry of the recess 46 in the support plate 22 and the cutting surface insert 40 provides a form-fitting connection and prevents them from detaching from one another. The geometry may also be different than that shown in the drawing.

The disclosure is not limited to the exemplary embodiments shown; in particular, the features described can also be combined in any way.

1. A cutting board having comprising:
a support plate, on which an item to be cut is configured to be placed for the cutting process,
a backing plate for the item to be cut connected to the support plate,
wherein the backing plate and the support plate form an angle of around 70° to 120° in an assembled state.

2. The cutting board according to claim 1, wherein the support plate and the backing plate are releasably connected to one another.

3. The cutting board according to claim 2, wherein the support plate has a groove, into which the backing plate is configured to be inserted such that the backing plate it is held therein when the cutting board is in use.

4. The cutting board according to claim 1, wherein the cutting board has a magnet, which is arranged and designed such that the magnet holds a metallic object on the cutting board.

5. The cutting board according to claim 4, wherein the magnet is arranged on the backing plate.

6. The cutting board according to claim 1, wherein the cutting board has a slot for receiving an object.

7. The cutting board according to claim 6, wherein the slot is arranged in the backing plate.

8. The cutting board according to claim 1, wherein the support plate has non-slip feet on its bottom.

9. The cutting board according to claim 1, wherein the support plate has a cutting surface insert, which is made of a different material from the support plate.

10. The cutting board according to claim 9, wherein the cutting surface insert is connected to the support plate in a form-fitting and removable manner.

11. The cutting board according to claim 9, wherein the cutting surface insert and support plate are magnetically connected to one another.

12. The cutting board according to claim 1, wherein the support plate and/or backing plate are made of wood.

13. The cutting board according to claim 1, wherein the support plate and/or backing plate are made of plastic.
